(19) United States
(12) Patent Application Publication
(10) Pub. No.: US 2016/0037844 A1
(43) Pub. Date: Feb. 11, 2016

(54) Hook Coupling

(71) Applicant: Lam Yuet WA, San Po Kong (HK)

(72) Inventor: Lam Yuet WA, San Po Kong (HK)

(21) Appl. No.: 14/629,258

(22) Filed: Feb. 23, 2015

(30) Foreign Application Priority Data
Aug. 5, 2014 (CN) 201420437919.2

(51) Int. Cl. A41F 1/00; F16B 45/02

(52) U.S. Cl. CPC A41F 1/00; F16B 45/02

(57) ABSTRACT

The invention discloses a hook coupling comprising a principal hook body and two blocking members disposed thereon to block any object inserted into the principal hook body. The hook coupling can make the inserted object (such as shoulder belts) to be very conveniently inserted into the hook coupling. In addition, after the shoulder belts are inserted, one blocking member can compress the shoulder belts, and the other blocking member can completely seal the clearance for inserting the shoulder belts, which result in the shoulder belts being not slid out from the hook coupling.

### CROSS REFERENCE TO THE RELATED APPLICATION

The present invention claims the benefit and priority to China patent application CN201420437919.2 filed on Aug. 5 , 2014, which is incorporated herein by reference in its entirety.

### TECHNICAL FIELD OF THE INVENTION

The present invention generally relates to an accessory for garment, and more particularly to a hook coupling for garment.

### BACKGROUND OF THE INVENTION

Hook couplings are usually equipped on different garments for connecting different positions of the garment, such as the shoulder belts of bras, binding band of the garment cuffs, and so on. Taking the bras as the example, the bras usually consist of tie band, shoulder belts, hook couplings, cups and back connecting members. However, the hook couplings in prior art may easily make the shoulder belts to slide.

Thus, the skilled in the art also attempts to resolve such problems. For example, U.S. Pat. No. 1,914,301 discloses a bras and its fittings, in which the hook couplings connecting the shoulder belts broke through the traditional connecting structure. At one end of the hook coupling, a blocking structure that can prevent the shoulder belts from sliding out after going through the shoulder belts. After the shoulder belts are inserted, the shoulder belts are not easy to slide out. Although the structure above can prevent slide out of the shoulder belts in certain degree, the blocking member of protrusion makes the shoulder belts to be inserted very difficultly, and a gap is still existed at the clearance for insertion, which cannot completely prevent sliding out of the shoulder belts.

Therefore, it is necessary to design a new hook coupling to resolve the problem that the shoulder belt easily slide out in prior art for a long time, which can facilitate mutual connection between the shoulder belts and the hook coupling.

### SUMMARY OF THE INVENTION

The object of the invention is to provide a new hook coupling, which cannot only make the shoulder belts to be easily inserted into the hook coupling, but also not easily to slide out from the hook coupling after being inserted into the hook coupling.

For achieving the above object, the invention takes the following technical resolution:

a hook coupling comprising:
a principal hook body which comprises a first flat and straight member and a second flat and straight member, and a first arc-shaped member and a second arc-shaped member that are connected with the first flat and straight member and the second flat and straight member respectively to form a flat ring-shaped element having a central hole therein; and
a third flat and straight member which is connected to the second flat and straight member by a third arc-shaped member;
wherein the hook coupling further comprises:
a first blocking member extending downwardly toward the third flat and straight member, which is disposed on the second flat and straight member; and
a second blocking member extending upwardly toward the second flat and straight member, which is disposed at one end of the third flat and straight member;
and wherein a sharp angle between one side of one end of the second blocking member and the third flat and straight member is created for ease of insertion.

The hook coupling according to the invention, the sharp angle is 30°-75°, and the outer side of the second blocking member has an arc transition. Preferably, he sharp angle is 45°.

The hook coupling according to the invention, the hook coupling further comprises a third blocking member located on the principal hook body of the hook coupling in order to seal or open the clearance between the second flat and straight member and the third flat and straight member.

The hook coupling according to the invention, one end of the third blocking member is located on the first arc-shaped member by a cramp, in which the third blocking member can be rotated around the cramp.

The hook coupling according to the invention, the third blocking member is located on the first arc-shaped member by a cramp, in which the third blocking member can be moved upwardly and downwardly by the cramp.

The hook coupling according to the invention, the third blocking member is located on the second blocking member by a cramp, in which the third blocking member can be moved upwardly and downwardly by the cramp.

The hook coupling according to the invention, the third blocking member is located on the first blocking member or the second flat and straight member by a cramp, in which the third blocking member can be moved upwardly and downwardly by the cramp.

The hook coupling according to the invention, one end of the third blocking member is located on the first arc member by a cramp, and a through hole is located on the blocking member; in which the other end of the third blocking member is a cramp which can be inserted into the through hole, or be pulled out from the through hole.

The hook coupling according to the invention, the third blocking member is located on the second blocking member by a cramp, and the third blocking member can be rotated around the cramp.

In the hook coupling of the invention, a tip with arc at one end of the hook coupling can renders the inserted object (such as shoulder belts) to be inserted into the hook coupling very conveniently.

Furthermore, after the object is inserted, because the second blocking member can compress the object, and the third blocking member can completely seal the clearance for inserting the object, the object will not be slid out from the hook coupling.

### BRIEF DESCRIPTION OF THE DRAWINGS

The features of the present invention may be clearly set forth with reference to the accompanying drawings. The invention, together with the advantages thereof may be best understood by reference to the following description taken in conjunction with the accompany drawings, wherein like reference signs identify like elements, and wherein:

FIG. 1 is a schematic view of a hook coupling according to one embodiment of the this invention;

FIG. 2 is a schematic view of a hook coupling according to another embodiment of the this invention;

FIG. 3 is another schematic view of the hook coupling in FIG. 2;

FIG. 4 is a schematic view of a hook coupling according to another embodiment of the this invention;

FIG. 5 is another schematic view of the hook coupling in FIG. 4;

FIG. 6 is a schematic view of a hook coupling according to another embodiment of the this invention;

FIG. 7 is another schematic view of the hook coupling in FIG. 6;

FIG. 8 is a schematic view of a hook coupling according to another embodiment of the this invention;

FIG. 9 is another schematic view of the hook coupling in FIG. 8;

FIG. 10 is a schematic view of a hook coupling according to another embodiment of the this invention;

FIG. 11 is another schematic view of the hook coupling in FIG. 10;

FIG. 12 is a schematic view of a hook coupling according to another embodiment of the this invention; and

FIG. 13 is another schematic view of the hook coupling in FIG. 12.

### DETAILED DESCRIPTION OF THE INVENTION

The structure of the hook coupling of the invention will be explained in detail with reference to the accompany drawings. The description and explanatory embodiment herein are merely used to set forth the present invention, not to limit the invention.

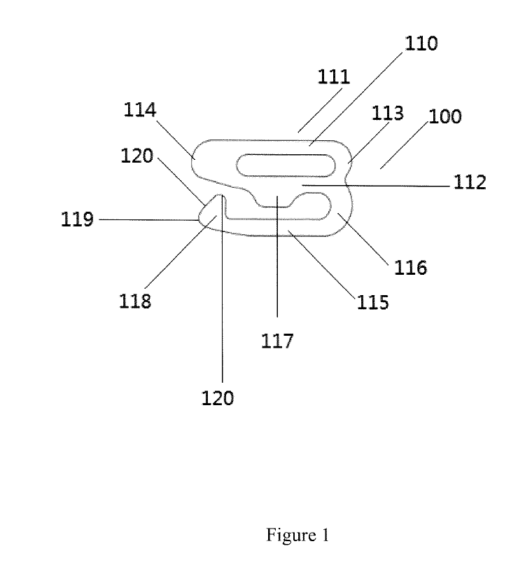

According to the present invention a hook coupling 100 shown in FIG. 1 is disclosed. The hook coupling 100 includes a principal hook body 111 which is made of suitable materials, such as alloy, plastic and so on. The principal hook body 111 is surrounded with a first flat and straight member 110, a second flat and straight member 112, a first arc member 114 and a second arc member 113, thus a flat ring-shape element with hole at the central position is formed. Further, the second flat and straight member 112 of the principal hook body 111 of the hook coupling 100 is connected to the third flat and straight member 115 by a third arc member 116, and certain clearance is formed between the second flat and straight member 112 and the third flat and straight member 115 for the other object to be inserted.

To prevent the inserted object from sliding out from the clearance, a first blocking member 117 is disposed on the second flat and straight member 112, which extends downwardly towards the third flat and straight member 115 to form a protrusion for blocking the object inserted into the clearance. Preferably, the first blocking member 117 extends downwardly by 0.3-0.8 mm, and has a transverse length of 3-6 mm in order to achieve the optimal blocking effect.

A second blocking member 118 is disposed on one end of the third flat and straight member 115, which extends upwardly toward the second flat and straight member. For conveniently introducing the object, the outer side of the second blocking member 118 is designed to form certain angle with respect to the third flat and straight member 115, so as to form a protrusive hook-shaped member. Generally, such angle is set to be a sharp angle, and the user can introduce the object to be inserted by the outer side of the second blocking member 118. Preferably, in order to achieve better introducing effect, the angle is 30°-75°. More preferably, the angle is 45°. Such configuration can be greatly convenient for the user to save time and effort. For inserting more easily, the outer ends 119 and 120 of the second blocking member 118 have an arch transition respectively.

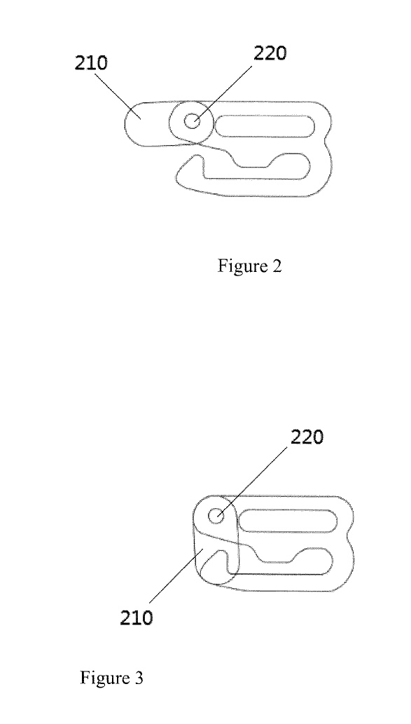

To completely prevent sliding out of the inserted object, a third blocking member is located on the principal hook body 111 of the hook coupling 100 in order to seal or open the clearance between the second flat and straight member 112 and the third flat and straight member 115. In one embodiment, as shown in FIG. 2 and FIG. 3, the third blocking member 210 is set at the arc-shaped member 114 by a cramp 220, and the third blocking member 210 can be rotated around the cramp 220 in order to seal or open the clearance between the second flat and straight member 112 and the third flat and straight member 115, and the inserted object will not be slid out from the hook coupling 100. In this embodiment and the following embodiments, the cramp is mounted in the pre-set hole in the principal hook body of the hook coupling by a method that familiar with by those skilled in the art, which is omitted herein.

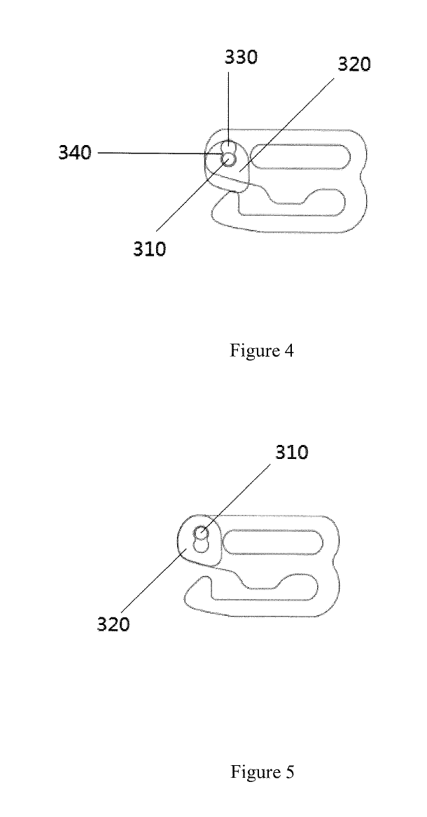

In another embodiment shown as FIG. 4 and FIG. 5, the third blocking member 320 is located on the first arc-shaped member 114 by the cramp 310, and the third blocking member 320 can be moved upwardly and downwardly by the cramp 310. Specifically, two holes 330 is designed in the middle of the third blocking member 320 for making the cramp 310 to slide. And a smaller position 340 is designed between the upper and the lower holes, which can render the third blocking member 320 being not slid freely.

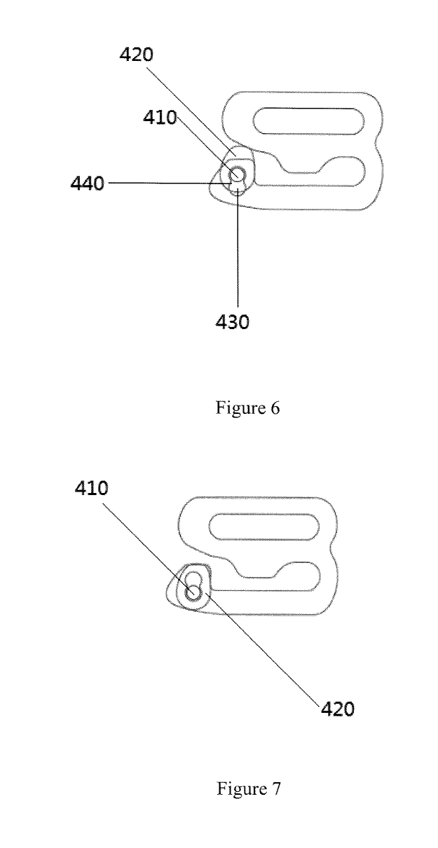

In another embodiment shown as FIG. 6 and FIG. 7, the third blocking member 420 is located on the second blocking member 118 by the cramp 410, and the third blocking member 420 can be moved upwardly and downwardly by the cramp 410. Specifically, two holes 430 are designed in the middle of the third blocking member 420 for making the cramp 410 to slide. And a smaller position 440 is designed between the upper and the lower holes, which can render the third blocking member 420 being not slid freely.

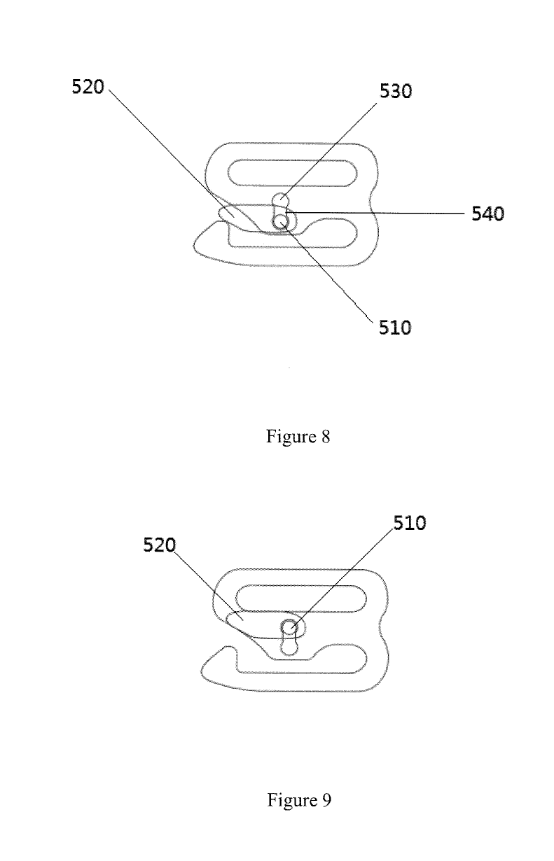

In another embodiment shown as FIG. 8 and FIG. 9, the third blocking member 520 is located on the first blocking member 117 by the cramp 510, and the third blocking member 520 can be moved upwardly and downwardly by the cramp 510. In this embodiment, the third blocking member 520 can also be located on the second flat and straight member 112, depending on the design requirements or market requirement. Specifically, two holes 530 are designed in the middle of the third blocking member 520 for making the cramp 510 to slide. And a smaller position 540 is designed between the upper and the lower holes, which can render the third blocking member 520 being not slid freely.

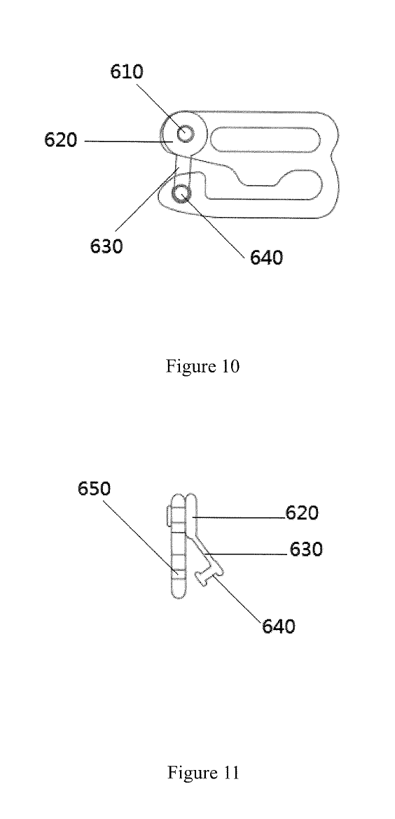

In another embodiment shown as FIG. 10 and FIG. 11, one end of the third blocking member 620 is disposed on the first arc-shaped member 114 by the cramp 610. A through hole 650 is design on the second blocking member 118, and the other end 640 of the third blocking member 620 is the cramp, which can be inserted into the through hole 650 or be pulled out from the through hole 650. With this setting, the clearance between the second flat and straight member 112 and the third flat and straight member 115 can be sealed or opened by the third blocking member 620.

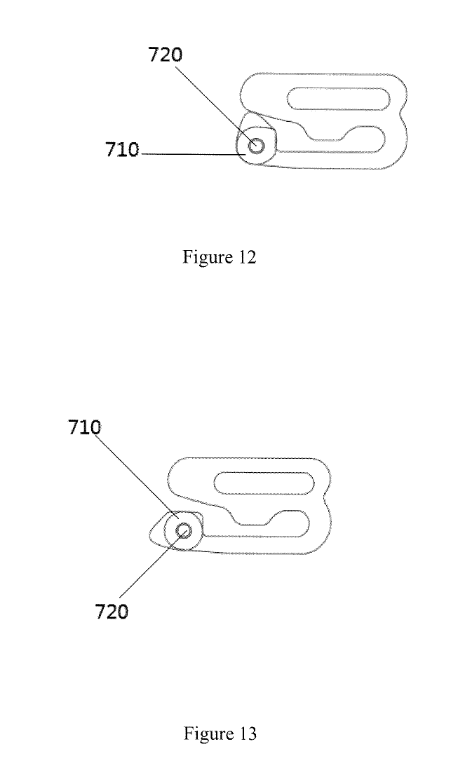

In yet another embodiment shown as FIG. 12 and FIG. 13, the third blocking member 710 is located on the second blocking member by the cramp 720, and the third blocking member 710 can be rotated clockwise by the cramp 710 in order to optimize the sealing or opening the clearance between the second flat and straight member 112 and the third flat and straight member 115.

Preferably, according to the hook coupling 100 of this invention, the first flat and straight member 110, the second flat and straight member 112, the first arc-shaped member 114 and the second arc-shaped member 113, the third arc-shaped member 116, the third flat and straight member 115, the first blocking member 117 and the second blocking member 118 are formed an integrity. Of course, the hook coupling 100 can designed to assemble by several elements, depending on the actual demand, such as the first flat and straight member 110, the second flat and straight member 112, the first arc-shaped member 114 and the second arc-shaped member 113 are formed to a first component, and the third arc-shaped member 116, the third flat and straight member 115, the first blocking member 117 and the second blocking member 118 are formed to a second component, in which the first component and the second component can be removably assembled to for an integrity.

The hook coupling of the present invention can make the inserted object (such as shoulder belts) to be very conveniently inserted into the hook coupling. In addition, after the shoulder belts are inserted, the second blocking member can compress the shoulder belts, and the third blocking member can completely seal the clearance for inserting the shoulder belts, which result in the shoulder belts being not slid out from the hook coupling.

While a particular embodiment of the invention has been shown and described, it will be obvious to those skilled in the art that changes and modifications can be made without departing from the true spirit and scope of the invention. It should be understood that the embodiments of the present invention described above are illustrative only, and all the changes and modifications made by those skilled in the art are covered by the appended claims.

What is claimed is:

1. A hook coupling comprising:
a principal hook body which comprises a first flat and straight member and a second flat and straight member, and a first arc-shaped member and a second arc-shaped member that are connected with the first flat and straight member and the second flat and straight member respectively to form a flat ring-shaped element having a central hole therein; and
a third flat and straight member which is connected to the second flat and straight member by a third arc-shaped member;
wherein the hook coupling further comprises:
a first blocking member extending downwardly toward the third flat and straight member, which is disposed on the second flat and straight member; and
a second blocking member extending upwardly toward the second flat and straight member, which is disposed at one end of the third flat and straight member;
and wherein a sharp angle between one side of one end of the second blocking member and the third flat and straight member is created for ease of insertion.

2. The hook coupling according to claim 1, wherein the sharp angle is 30°-75°, and the outer side of the second blocking member has an arc transition.

3. The hook coupling according to claim 2, wherein the sharp angle is 45°.

4. The hook coupling according to claim 1, wherein the hook coupling further comprises a third blocking member located on the principal hook body of the hook coupling in order to seal or open the clearance between the second flat and straight member and the third flat and straight member.

5. The hook coupling according to claim 4, wherein one end of the third blocking member is located on the first arc-shaped member by a cramp, in which the third blocking member can be rotated around the cramp.

6. The hook coupling according to claim 4, wherein the third blocking member is located on the first arc-shaped member by a cramp, in which the third blocking member can be moved upwardly and downwardly by the cramp.

7. The hook coupling according to claim 4, wherein the third blocking member is located on the second blocking member by a cramp, in which the third blocking member can be moved upwardly and downwardly by the cramp.

8. The hook coupling according to claim 4, wherein the third blocking member is located on the first blocking member or the second flat and straight member by a cramp, in which the third blocking member can be moved upwardly and downwardly by the cramp.

9. The hook coupling according to claim 4, wherein one end of the third blocking member is located on the first arc member by a cramp, and a through hole is located on the blocking member; in which the other end of the third blocking member is a cramp which can be inserted into the through hole, or be pulled out from the through hole.

10. The hook coupling according to claim 4, wherein the third blocking member is located on the second blocking member by a cramp, and the third blocking member can be rotated around the cramp.
